(19) United States
(12) Patent Application Publication
(10) Pub. No.: US 2010/0278574 A1
(43) Pub. Date: Nov. 4, 2010

(54) IMAGE FORMING APPARATUS

(75) Inventor: Hideaki Miyazawa, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/727,626

(22) Filed: Mar. 19, 2010

(30) Foreign Application Priority Data
Apr. 30, 2009 (JP) 2009-111007

(51) Int. Cl. G03G 15/14

(52) U.S. Cl. 399/400

(57) ABSTRACT

A before-toner-fixation conveying guide is provided between a transfer portion configured to transfer a toner image, which is formed by an image forming portion, onto a sheet and a fixing portion configured to fix the toner image, which is transferred on the sheet by the transfer portion, to the sheet. The before-toner-fixation conveying guide guides the sheet, on which the toner image is transferred, to the fixing portion. A plurality of consecutive chevron shapes are formed, along a direction orthogonal to a sheet conveying direction, in an end portion on a downstream side in the sheet conveying direction of the before-toner-fixation conveying guide.

### BACKGROUND OF THE INVENTION

1. Field of the Invention

The present invention relates to an image forming apparatus, and more particularly, to a structure of a guide member, which is provided between a transfer portion and a fixing portion, for guiding a sheet, on which a toner image is transferred, to the fixing portion.

2. Description of the Related Art

Conventionally, in an image forming apparatus such as a printing machine, a copying machine, a FAX, and a printer, there is one in which an image is formed on a sheet by an electrophotographic process. In such image forming apparatus, in order to form the image on the sheet, a photosensitive drum is first exposed to the light in accordance with image information so as to form an electrostatic latent image on the photosensitive drum. Next, by developing the electrostatic latent image in the developing device with toner, the electrostatic latent image is visualized as a toner image. Then, the sheet is fed from the sheet feeding portion to a transfer portion, and the toner image is transferred on the sheet in the transfer portion. After that, the sheet is conveyed to a fixing nip between a fixing roller and a pressure roller in a fixing portion. Then, the toner image is fixed on the sheet as a permanent image.

In this case, the sheet is conveyed from the transfer portion to the fixing portion by an air-suction-type conveyer belt in order to suppress flutter of the sheet immediately after transferring. Further, in order to accurately guide the sheet, which is conveyed by the conveyer belt immediately after transferring, to the fixing nip, a conveying guide member is provided between the conveyer belt and the fixing portion. FIG. 7 is a top view of such conventional conveying guide member 100. On a guiding surface 104 of the conveying guide member 100 for guiding the sheet, a plurality of ribs 103 extending in a sheet conveying direction are formed so as to be arranged along a width direction orthogonal to the sheet conveying direction. As described above, the plurality of ribs 103 are formed on the guiding surface 104, and hence a conveying resistance during sheet conveyance is reduced.

By the way, due to scattered toner upon transferring or due to jam clearance operation, unfixed toner may adhere to the conveyer belt. As described above, when the unfixed toner adheres to the conveyer belt, the adhering unfixed toner, in turn, adheres to a back surface of the sheet. Further, toner stain spreads, through the back surface of the sheet, toward the conveying guide member downstream in the sheet conveying direction. As a result, as illustrated in FIG. 8, the toner stain T is finally accumulated on a side wall surface of a downstream end in the sheet conveying direction of the conveying guide member 100.

Meanwhile, the sheet is conveyed by the conveyer belt 310 to the fixing nip N formed between the fixing roller 301 and a fixing lower belt 302. In this case, when the sheet passes through the fixing nip N, a trailing edge of the sheet is upwardly curled as indicated by the broken line of FIG. 9. After that, when the trailing edge passes through the conveying guide member 100, the conveying guide member 100 does not support the trailing edge anymore, and hence the trailing edge is downwardly deflected as indicated by the solid line of FIG. 9. When the trailing edge is downwardly deflected, as illustrated in FIG. 9, the trailing edge of the sheet scrapes off the toner stain T accumulated on the side wall surface of the conveying guide member 100. As a result, the back surface of the trailing edge of the sheet is stained, which leads to unexpected generation of stain T′ on a fore-edge of the trailing edge during continuously sheet-passing. In addition, the toner stain T′ scraped off by the sheet, which is illustrated in FIG. 9, adhere to the fixing lower belt 302 illustrated in FIG. 8, and then, the toner stain T′ adhering to the fixing lower belt 302 is fixed again to a back surface of a subsequent sheet. As a result, a defective image having streaks in the width direction thereof is generated.

Therefore, conventionally, the conveying guide member is regularly cleaned. However, when the image forming apparatus is, for example, used as a high-productivity copying-machine, the conveying guide member may not be regularly cleaned because the sheet is needed to continuously pass therethrough. With this regards, in order to prevent the scattered toner from adhering to the trailing edge of the sheet as described above, rotatable members are conventionally provided in a downstream end portion in the sheet conveying direction of the conveying guide member 100 as described in Japanese Patent Application Laid-Open No. 2001-261185. Further, as described in Japanese Patent Application Laid-Open No. H08-146795, the conveying guide member 100 is covered with a PFA tube having a resistance value of from 10⁶ to 10¹² Ω, that is, having a high toner releasing ability. Thus, accumulation of the toner and adhesion of the toner due to triboelectrification caused by a friction of the sheet with the conveying guide member 100 are prevented.

By the way, in the conventional image forming apparatus, in a case where thin sheets are used, when the sheet passes through the fixing nip N in a state in which the sheet is skew-fed, wrinkles may be generated in the sheet. Therefore, the sheet is caused to come into contact with the fixing roller 301 so as to correct skew feeding of the sheet. In this case, it is necessary to bring a downstream edge of the conveying guide member close to the fixing nip N as much as possible. However, as described above, in a case where the downstream end portion in the sheet conveying direction of the conveying guide member is provided with the rotatable members, it is impossible to bring the downstream edge of the conveying guide member close to the fixing nip N due to the size of the rotatable members even if it is desired to bring the downstream edge of the conveying guide member close to the fixing nip N. Consequently, the conventional image forming apparatus is incapable of accommodating the thin sheets. On the other hand, in a case where the conveying guide member is covered with the PFA tube, the PFA may be pealed off when the sheet and the PFA are rubbed together. Thus, there are problems in that sufficient durability cannot be obtained for further speeding-up and increased productivity, and in that the cost is increased because it is required to apply bias to an inlet guide.

### SUMMARY OF THE INVENTION

Therefore, the present invention has been made in view of such circumstance, and it is an object of the present invention to provide an image forming apparatus capable of preventing scattered toner from adhering to a trailing edge of a sheet.

The present invention provides an image forming apparatus, including: an image forming portion configured to form a toner image; a transfer portion configured to transfer the toner image, which is formed by the image forming portion, onto a sheet; a fixing portion configured to fix the toner image, which is transferred by the transfer portion, on the sheet; and a guide member provided between the transfer portion and the fixing portion to guide the sheet, on which the toner image is transferred by the transfer portion, to the fixing portion, wherein a plurality of consecutive chevron shapes are formed, along a direction orthogonal to a sheet conveying direction, in a downstream end portion of the guide member in the sheet conveying direction.

Further features of the present invention will become apparent from the following description of exemplary embodiments with reference to the attached drawings.

### BRIEF DESCRIPTION OF THE DRAWINGS

FIG. 1 is a view illustrating a schematic structure of a color image forming apparatus according to an embodiment of the present invention.

FIG. 2 is an enlarged side view of a relevant part of the color image forming apparatus.

FIG. 3 is an enlarged top view of the relevant part of the color image forming apparatus.

FIG. 4 is a top view of a before-toner-fixation conveying guide provided in the color image forming apparatus.

FIG. 5 is a top view illustrating another before-toner-fixation conveying guide.

FIGS. 6A and 6B are views illustrating still another before-toner-fixation conveying guide.

FIG. 7 is a top view of a conventional before-toner-fixation conveying guide.

FIG. 8 is a cross-sectional view illustrating toner stain of the conventional before-toner-fixation conveying guide.

FIG. 9 is a view illustrating the conventional before-toner-fixation conveying guide, behaviors of a trailing edge of a sheet, and a generation of stain on a fore-edge of the trailing edge.

### DESCRIPTION OF THE EMBODIMENTS

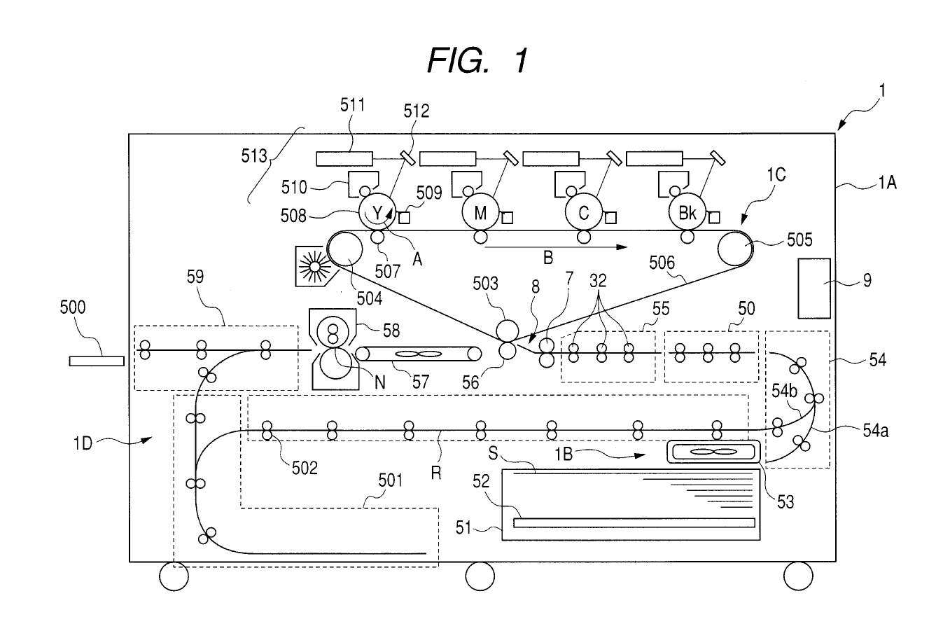

Hereinafter, an embodiment for implementing the present invention is described in detail with reference to the drawings. FIG. 1 is a view illustrating a schematic structure of a color image forming apparatus as one example of an image forming apparatus according to an embodiment of the present invention. FIG. 1 illustrates the color image forming apparatus 1 and the color image-forming-apparatus main body (hereinafter, referred to as apparatus main body) 1A. Note that, the color image forming apparatus is mainly classified, in view of its structure, into a tandem type apparatus in which a plurality of image forming portions are arranged side by side, and into a rotary type apparatus in which the plurality of image forming portions are arranged in a cylindrical manner. Further, as a transferring process, there are a directly transferring process by which a toner image is directly transferred on a sheet from a photosensitive drum, and an intermediate transferring process by which the toner image is transferred on an intermediate transfer member before the toner image is transferred on the sheet. Note that, it is unnecessary for the intermediate transferring process to retain the sheet on a transferring belt as in the directly transferring process, and hence, in the intermediate transferring process, it is possible to accommodate various sheets such as ultra-heavy paper and coat paper. Further, the intermediate transferring process is characterized by parallel-processing in the plurality of image forming portions and by collectively-transferring of a full-color image, and hence the intermediate transferring process is suitable for achieving a mass-productivity. The color image forming apparatus 1 according to this embodiment is the intermediate transferring tandem type apparatus in which image forming units for four colors are arranged side by side on an intermediate transferring belt.

The apparatus main body 1A comprises: an image forming portion 513; a sheet feeding portion 1B configured to feed a sheet S; and a transfer portion 1C configured to transfer a toner image, which is formed by the image forming portion 513, on the sheet S fed by the sheet feeding portion 1B. Further, the apparatus main body 1A is further provided with a sheet conveying device 1D configured to convey the sheet. The image forming portion 513 comprises image forming units for yellow (Y), magenta (M), cyan (C), and black (Bk), each of which includes the photosensitive drum 508, an exposure device 511, a developing device 510, a primary transferring device 507, and a cleaner 509. Note that, the colors to which the image forming units are respectively dedicated are not limited to the above-mentioned four colors, and an arranging order for colors is not limited thereto.

The sheet feeding portion 1B comprises a sheet containing portion 51 configured to contain the sheets S in such a manner that the sheets S are stacked on a lifting-up device 52; and a sheet feeding means 53 for feeding the sheets S contained in the sheet containing portion 51. As the sheet feeding means 53, there are exemplified a type using frictional separation by a sheet feeding roller or the like, a type using separation suction by the blown air, or the like. In this embodiment, the blown air sheet feeding device is exemplified. Further, the transfer portion 1C has an intermediate transferring belt 506, which is stretched around a drive roller 504, a tension roller 505, and a secondary transferring inner roller 503. The intermediate transferring belt 506 is moved in the direction indicated by the arrow B of FIG. 1. Here, the toner images, which are formed on the photosensitive drums, are transferred on the intermediate transferring belt 506 by a predetermined pressing force and an electrostatic load bias applied by the primary transferring device 507. Further, the intermediate transferring belt 506 causes an unfixed image to attract to the sheet S by applying a predetermined pressing force and an electrostatic load bias in a secondary transfer portion. Specifically, the secondary transfer portion is formed by the secondary transferring inner roller 503 and a secondary transferring outer roller 56, which are substantially opposed to each other.

The sheet conveying device 1D comprises: a conveyance unit 54; a conveying roller device 50; a skew-feed-correction device 55 constituting a skew-feed-correction portion; registration rollers 7; a before-toner-fixation sheet-conveying portion 57; a branching-point conveyance device 59; a reversal conveyance device 501; and a duplex conveying device 502. The before-toner-fixation sheet-conveying portion 57 conveys the sheet, on which the toner image is transferred by the secondary transfer portion, to a fixing nip N of a fixing device 58.

In the color image forming apparatus 1 having the above-mentioned structure, in order to form the image, the photosensitive drum 508 is first rotated to the direction indicated by the arrow A of FIG. 1. A surface of the photosensitive drum 508 is uniformly charged by a charging means (not shown) in advance. After that, a signal relating to image information is sent to the exposure device 511, and the exposure device 511 emits the light to the rotating photosensitive drum 508 according to the image information. The photosensitive drum 508 is irradiated with the light appropriately through a reflecting means 512 and the like. In this manner, a latent image is formed on the photosensitive drum 508. Note that, a few untransferred toner remained on the photosensitive drum 508 is recovered by the cleaner 509 so that the photosensitive drum 508 is ready for a subsequent image formation.

Next, as described above, the electrostatic latent image formed on the photosensitive drum 508 is developed with the toner by the developing device 510. As a result, the toner image is formed on the photosensitive drum. After that, the predetermined pressing force and the electrostatic load bias are applied by the primary transferring device 507. In this manner, the toner image is transferred onto the intermediate transferring belt 506. Respective image formations performed by the image forming units for yellow (Y), magenta (M), cyan (C), and black (Bk) in the image forming portion 513 are performed at a timing at which a toner image is superimposed on an upstream toner image, which has been primarily transferred on the intermediate transferring belt. As a result, a full-color toner image is finally formed on the intermediate transferring belt 506. The sheet S is fed by the sheet feeding means 53 in timed relation to the image formation timing of the image forming portion 513. After that, the sheet S passes through a conveyance path 54a provided in the conveyance unit 54, and is conveyed to the skew-feed-correction device 55 for correcting position-shifting and skew-feeding of the sheet during conveyance.

After position-shifting and skew-feeding of the sheet S are corrected by the skew-feed-correction device 55, the sheet S is conveyed to the registration rollers 7. Here, timing for conveyance of the sheet S is adjusted by the registration rollers 7. After that, the sheet S is conveyed to the secondary transfer portion formed between the secondary transferring inner roller 503 and the secondary transferring outer roller 56. After that, in the secondary transfer portion, the full-color toner image is secondarily transferred on the sheet S. Next, the sheet S on which the toner image is secondarily transferred as described above is conveyed to the fixing device 58 by the before-toner-fixation sheet-conveying portion 57. Then, in the fixing device 58, by applying predetermined pressing force and heating effect generally through a heat source such as a heater, the toner are fused and fixed on the sheet S. Next, the sheet S having the fixed image thus obtained is delivered onto a delivery tray 500 by the branching-point conveyance device 59 as it is. Note that, in a case where images are formed on the both surfaces of a sheet S, a switch member (not shown) is switched, and after that, the sheet S is conveyed to the reversal conveyance device 501.

Here, when the sheet S is conveyed to the reversal conveyance device 501 as described above, the leading edge and the trailing edge of the sheet S are reversed by a switch-back operation. Then, the sheet S is conveyed to a reconveyance path R provided in the duplex conveying device 502. After that, in timed relation to a sheet conveyed from the sheet feeding portion 1B for a subsequent job, the sheet S is conveyed from a sheet-refeeding path 54b provided in the conveyance unit 54 to join the conveyance path 54a, and is conveyed to the secondary transfer portion as in a case of the first surface. In this case, the sheet-refeeding path 54b is merged into the conveyance path 54a through which the first surface passes. The image formation process of the second surface is the same as for in a case of the first surface, and the description thereof is omitted. Note that, in the conveyance unit 54, the branching-point conveyance device 59, the reversal conveyance device 501, and the duplex conveying device 502, there are arranged a plurality of conveying rollers. Further, in the plurality of conveying rollers, each of driving rollers and each of driven rollers rotate while sandwiching the sheet therebetween, to thereby convey the sheet. Further, in the conveying rollers, the driven rollers is biased against the driving rollers by a biasing member such as a spring (not shown) or the like, respectively. Thus, pressure for nipping the sheet between both of the driving rollers and the driven rollers, respectively, is set.

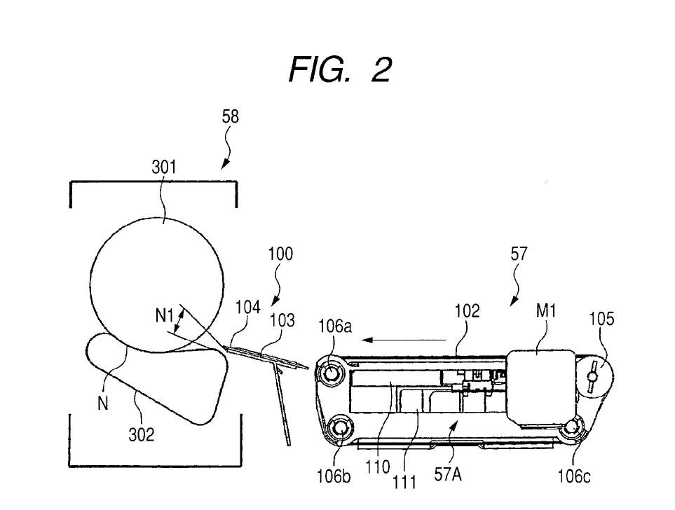

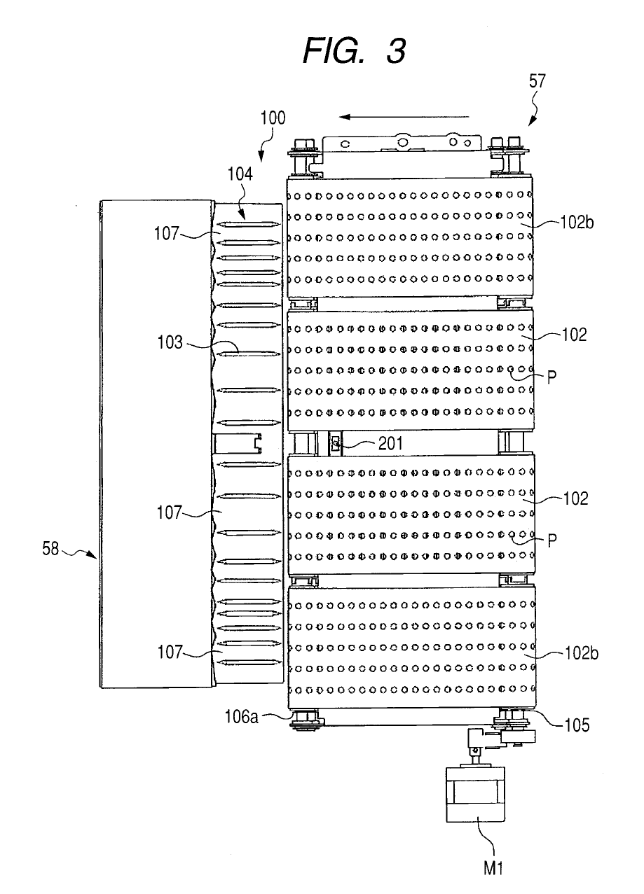

By the way, the before-toner-fixation sheet-conveying portion 57 for conveying the sheet to the fixing device 58 includes, as illustrated in FIG. 2 and FIG. 3, endless belts 102 for carrying and conveying the sheet S and suctioning the sheet S by air to suppress flutter of the sheet. Further, the before-toner-fixation sheet-conveying portion 57 includes an air suction portion 57A arranged inside the endless belts 102 for generating negative pressure with respect to a backside of a tensioned surface of the endless belts 102. The endless belts 102 are stretched around a driving roller 105 driven by a motor M1 and driven rollers 106a to 106c. The endless belts 102 are provided with a plurality of air suction holes (suction holes) P having round-hole shapes. Note that, on both sides of the two endless belts 102, there are provided auxiliary endless belts 102b for assisting conveyance of the sheet by the endless belts 102. The auxiliary endless belts 102b do not suction the sheet S, but assist conveyance only through friction of the belt with respect to both ends in a width direction of the sheet S.

Further, the air suction portion 57A comprises: a duct portion 110 constituting opening portions for air suction; and a suction fan 111 coupled to the duct portion 110. Note that, the duct portion 110 is provided inside the two endless belts 102 positioned in a center portion in a width direction of the before-toner-fixation sheet-conveying portion 57. Further, the duct portion 110 is provided with a plurality of slit-like air suction holes (not shown) communicated with the air suction holes P formed in the two endless belts 102 positioned in the center portion. When the suction fan 111 is rotated, the air is suctioned into the duct portion through the air suction holes formed in the duct portion 110 and through the air suction holes P of the endless belts 102, so that the sheet S is suctioned onto surfaces of the endless belts. In this manner, the sheet S is conveyed through rotation of the endless belts 102 in the direction indicated by the arrow while the sheet S is suctioned on the surfaces of the endless belts 102. As described above, the sheet is suctioned onto the conveyer belts so as to be conveyed, and hence flutter of the sheet S during conveyance is suppressed. Thus, it is possible to stably convey the sheet without adversely affect the toner image.

FIG. 2 illustrates the fixing roller 301 for heating the sheet, and the fixing lower belt 302. The fixing lower belt 302 comes into pressure contact with the fixing roller 301, to thereby form the curving fixing nip N. A before-toner-fixation conveying guide 100 as a guide member is provided between the secondary transfer portion and the fixing device 58 serving as a fixing portion, for guiding the sheet, on which the toner image is transferred, to the fixing device 58. The before-toner-fixation conveying guide 100 is arranged so that a downstream end of the before-toner-fixation conveying guide 100 in the sheet conveying direction is positioned above the fixing lower belt 302 of the fixing device 58. The before-toner-fixation conveying guide 100 and the before-toner-fixation conveying device 57 form a sheet conveyance path up to the fixing device 58.

In FIG. 2, a distance of a gap between the downstream end of the before-toner-fixation conveying guide and the fixing lower belt 302 is designated by a reference sign N1. When a sheet having the leading edge downwardly curled enters the gap between the before-toner-fixation conveying guide 100 and the fixing lower belt 302, uneven glossy, wrinkles, or the like is generated in the leading edge of the sheet. Therefore, for the purpose of ensuring the distance N1, the before-toner-fixation conveying guide 100 is provided so as to be arranged close to the fixing lower belt 302 with high accuracy. With this, the sheet on which the toner image is unfixed can be stably conveyed to the fixing nip N.

Further, as illustrated in FIG. 3, on the guiding surface 104 constituted by an upper surface of the before-toner-fixation conveying guide 100, a plurality of conveyance ribs 103 are arranged along a width direction orthogonal to the sheet conveying direction. The conveyance ribs 103 are extended in the sheet conveying direction for reducing conveying load upon sheet passing. Further, an end portion on a downstream side in the sheet conveying direction of the guiding surface 104 includes a plurality of consecutive chevron shapes 107 formed along the width direction.

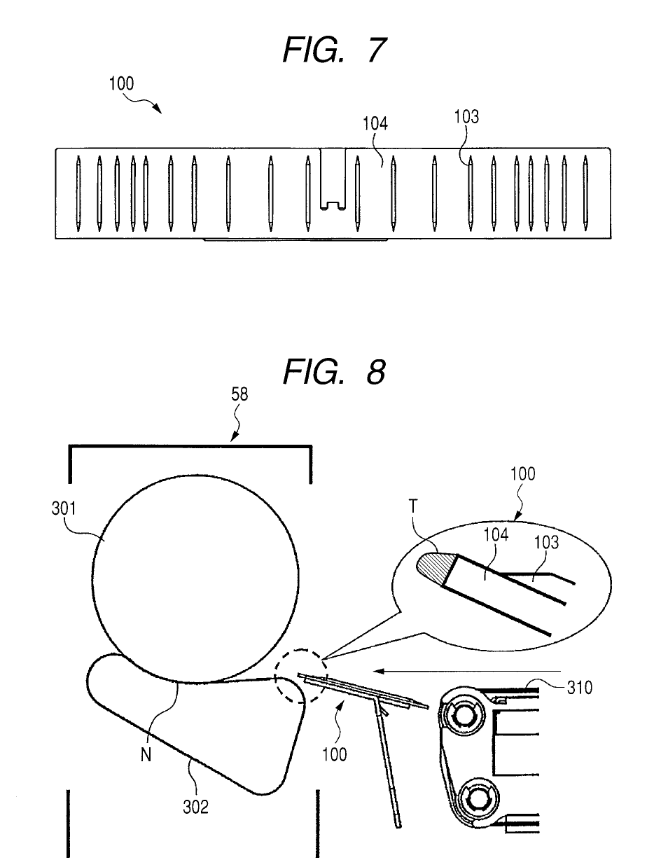

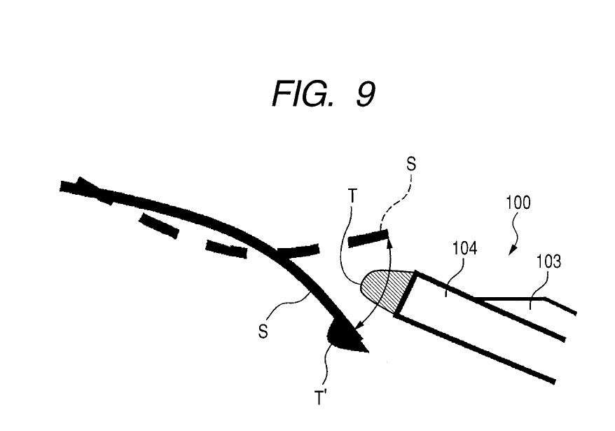

If, as in the conventional conveying guide as illustrated in FIG. 7, which is described in the above, for example, the end portion on the downstream side in the sheet conveying direction is flat, toner stain and the like are accumulated along the width direction on the side wall surface of the end portion on the downstream side in the sheet conveying direction of the guiding surface 104 as illustrated in FIG. 9. As a result, when the trailing edge of the sheet passes through the guiding surface 104, the accumulated toner stain and the like adhere to the trailing edge of the sheet, and hence streak stain on the fore-edge is generated. With this regard, in this embodiment, the plurality of chevron shapes are formed in the end portion on the downstream side in the sheet conveying direction of the before-toner-fixation conveying guide 100, the plurality of chevron shapes being arranged along the width direction of the before-toner-fixation conveying guide 100. When the plurality of chevron shapes 107 are formed along the width direction as described above, toner stain and the like are gradually accumulated in valley portions (recessed portions) of the chevron shapes 107, but are not accumulated on vertexes of the chevron shapes 107. Further, when the trailing edge of the sheet passes through the before-toner-fixation conveying guide 100, the trailing edge of the sheet first contact the vertexes of the chevron shapes 107. Therefore, the accumulated toner stain does not adhere to the trailing edge of the sheet, and hence image defection due to toner stain on the fore-edge does not occur. In this way, as the chevron shapes 107 in the embodiment are formed in the side wall surface of the end portion on the downstream side in the sheet conveying direction of the before-toner-fixation conveying guide 100, it is possible to prevent the scattered toner from adhering to the trailing edge of the sheet.

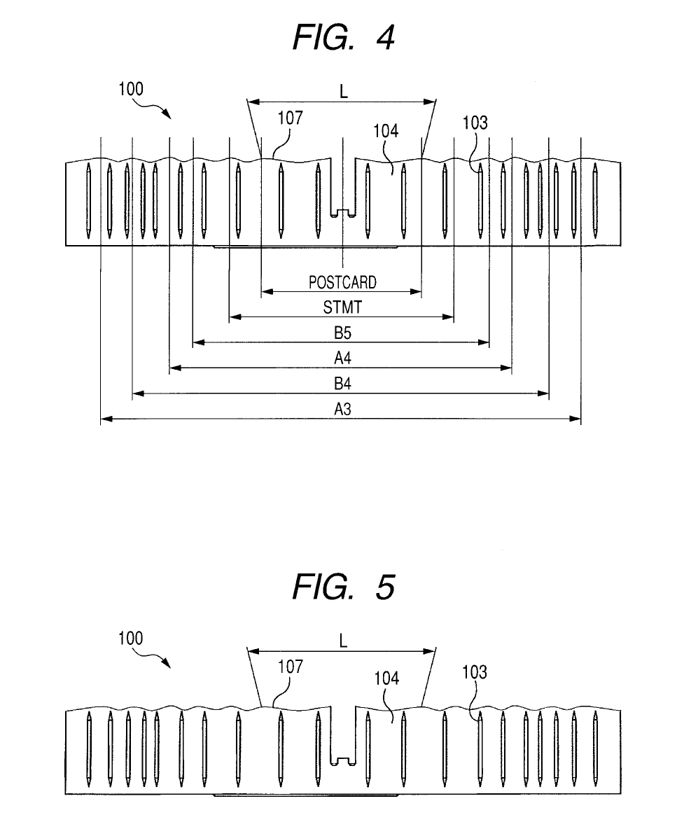

Note that, in FIG. 4, a distance between the vertexes of the chevron shapes 107 formed so as to be symmetrical about a sheet conveying center line serving as a center in the width direction of the sheet is designated by L. In this embodiment, the distance L is set to be substantially equal to a width of a sheet of a regular size (A3, B4, or the like). In this embodiment, the sheet is conveyed in such a manner that the center of the width direction of the sheet is aligned with the center of the sheet conveyance path. The vertexes of the chevron shapes 107 are arranged substantially in alignment with side edges of the sheet to be conveyed. Note that, the distance L between the vertexes of the chevron shapes 107 may be set to be slightly inwardly decreased also under consideration of flutter of the sheet during conveyance. By setting the distance L between the vertexes in this way, when the trailing edge of the sheet passes through the before-toner-fixation conveying guide 100, the trailing edge of the sheet is allowed to first contact the vertexes of the chevron shapes 107, and hence it is possible to prevent the scattered toner from adhering to the trailing edge of the sheet.

Note that, FIG. 5 is a top view illustrating a shape of a before-toner-fixation conveying guide 100 according to another structure in this embodiment. In this structure, positions of the vertexes of the chevron shapes 107 are set so that the center lines of the conveyance ribs 103 are aligned with the positions of the vertexes of the chevron shapes 107. That is, the vertexes of the chevron shapes 107 are set to be positioned in extensions in the longitudinal directions of the conveyance ribs 103. Each of the conveyance ribs 103 is small in area at an upper surface thereof, and hence the toner stain and the like are more unlikely to adhere thereto in comparison with the guiding surface 104. Therefore, a smaller amount of the toner stain and the like is accumulated on portions, which are corresponding to the conveyance ribs 103, of the side wall surface of the downstream side end in the sheet conveying direction of the before-toner-fixation conveying guide 100. Thus, the vertexes of the chevron shapes 107 are set to be positioned in the extensions in the longitudinal direction of the conveyance ribs 103 as described above, and hence it is possible to reduce accumulation of the unfixed toner on the vertex portions of the chevron shapes.

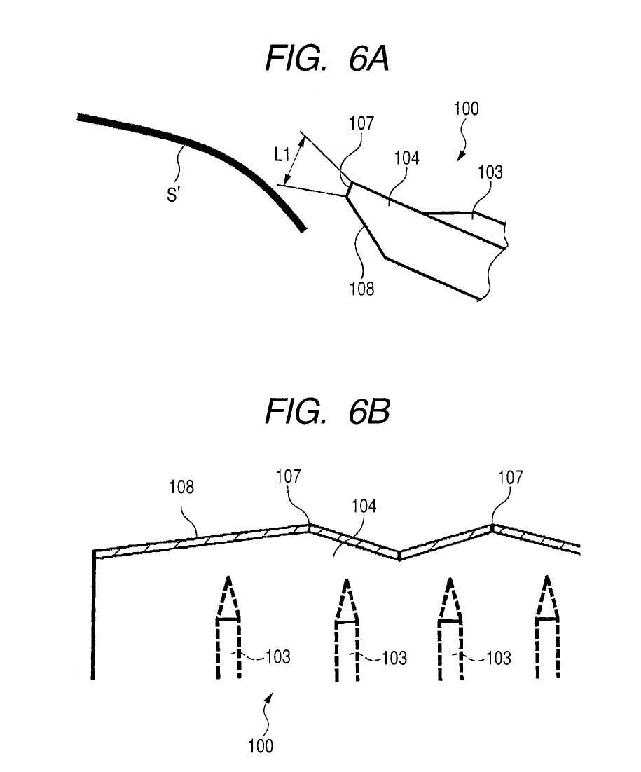

Further, FIGS. 6A and 6B are views illustrating a shape of the before-toner-fixation conveying guide 100 according to still another structure. Specifically, in the still another structure, a taper shape is formed in a lower surface, which is arranged on a side opposite to a sheet-passing surface, of each of the chevron shapes 107 of the before-toner-fixation conveying guide 100. As described above, a taper-shaped portion 108 is formed in the lower surface of each of the chevron shapes 107, the taper-shaped portion 108 getting closer to the upper surface (top surface) of the before-toner-fixation conveying guide 100 with progressing in the sheet conveying direction. In this way, a length L1 in cross section of each of the chevron shapes 107 can be reduced. With this, it is possible to reduce accumulation of the unfixed toner on the chevron shapes 107.

As described above, the plurality of chevron shapes 107 are formed along the width direction on the side wall surface of the downstream end in the sheet conveying direction of the before-toner-fixation conveying guide 100. Thus, it is possible to prevent the scattered toner from adhering to the trailing edge of the sheet. With this, even in a case where thin sheets are used, it is possible to convey the sheet without generation of the wrinkles and it is possible to prevent the stain of the scattered toner on the fore-edge of the sheet.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-111007, filed Apr. 30, 2009, which is hereby incorporated by reference herein in its entirety.

What is claimed is:

1. An image forming apparatus, comprising:
an image forming portion configured to form a toner image;
a transfer portion configured to transfer the toner image, which is formed by the image forming portion, onto a sheet;
a fixing portion configured to fix the toner image, which is transferred by the transfer portion, on the sheet; and
a guide member provided between the transfer portion and the fixing portion to guide the sheet, on which the toner image is transferred by the transfer portion, to the fixing portion,
wherein a plurality of consecutive chevron shapes are formed, along a direction orthogonal to a sheet conveying direction, in a downstream end portion of the guide member in the sheet conveying direction.

2. An image forming apparatus according to claim 1, wherein the sheet is conveyed so that a center in a width direction of the sheet is aligned with a center of a conveyance path between the transfer portion and the fixing portion, and
wherein the plurality of consecutive chevron shapes are formed to be symmetrical about the center in the width direction of the sheet.

3. An image forming apparatus according to claim 2, wherein vertexes of the plurality of consecutive chevron shapes are arranged substantially in alignment with side edges of the conveying sheet in the width direction orthogonal to the sheet conveying direction.

4. An image forming apparatus according to claim 1, wherein a plurality of conveyance ribs are provided on an upper surface of the guide member so as to be arranged in the width direction, the plurality of conveyance ribs extending along the sheet conveying direction, and
wherein vertexes of the plurality of consecutive chevron shapes are positioned in extensions in longitudinal directions of the plurality of conveyance ribs.

5. An image forming apparatus according to claim 1, wherein a surface on a lower side of the plurality of consecutive chevron shapes of the guide member is shaped into a taper shape getting closer to a surface side with progressing in the sheet conveying direction.
